(19) United States
(12) Patent Application Publication
(10) Pub. No.: US 2026/0081279 A1
(43) Pub. Date: Mar. 19, 2026

(54) BATTERY PACK

(71) Applicant: TOYOTA JIDOSHA KABUSHIKI KAISHA, Toyota-shi (JP)

(72) Inventor: Shingo KOMURA, Nagakute-shi (JP)

(73) Assignee: TOYOTA JIDOSHA KABUSHIKI KAISHA, Toyota-shi (JP)

(21) Appl. No.: 19/231,930

(22) Filed: Jun. 9, 2025

(30) Foreign Application Priority Data
Sep. 17, 2024 (JP) 2024-160162

(51) Int. Cl. H01M 50/242; B60L 50/64; H01M 10/613; H01M 10/625; H01M 10/647; H01M 10/6554; H01M 50/209; H01M 50/249

(52) U.S. Cl. CPC H01M 50/242; H01M 10/613; H01M 10/625; H01M 10/647; H01M 10/6554; H01M 50/209; H01M 50/249; B60L 50/64; H01M 2220/20

(57) ABSTRACT

A battery pack includes: a first battery module and a second battery module that are stacked together; and a cooling plate disposed between the first battery module and the second battery module. Each of the first battery module and the second battery module includes a cell stack that is a plurality of battery cells stacked together, and a frame having a frame shape and surrounding the periphery of the cell stack. The frame of the first battery module has a protrusion protruding toward the second battery module. The frame of the second battery module has a recess that receives the protrusion of the first battery module. The cooling plate has a hole or a notch through which the protrusion passes.

### CROSS-REFERENCE TO RELATED APPLICATION

This application claims priority to Japanese Patent Application No. 2024-160162 filed on Sep. 17, 2024. The disclosure of the above-identified application, including the specification, drawings, and claims, is incorporated by reference herein in its entirety.

### BACKGROUND

### 1. Technical Field

The technique disclosed in the present specification relates to battery packs.

### 2. Description of Related Art

Japanese Unexamined Patent Application Publication No. 2007-200712 (JP 2007-200712 A) describes a battery pack in which a plurality of battery modules is stacked together. These battery modules are clamped together using a clamp. Space is provided between adjacent battery modules by using spacers in order to allow cooling air to pass therethrough.

### SUMMARY

As described above, in a battery pack in which a plurality of battery modules is stacked together, it is desired to clamp the battery modules together and to effectively cool each battery module. The present specification provides a technique for implementing such clamping and cooling with a simple structure.

The technique disclosed the present specification is embodied in a battery pack. According to a first aspect of the present technique, a battery pack includes:
a first battery module and a second battery module that are stacked together; and
a cooling plate disposed between the first battery module and the second battery module.
each of the first battery module and the second battery module includes
a cell stack that is a plurality of battery cells stacked together, and
a frame made of resin, having a frame shape, and surrounding the periphery of the cell stack. The frame of the first battery module has a protrusion protruding toward the second battery module.

The frame of the second battery module has a recess that receives the protrusion of the first battery module.

The cooling plate has a hole or a notch through which the protrusion passes.

In the above battery pack, each of the battery modules includes a cell stack, and a frame is provided around the periphery of the cell stack.

The frame of the first battery module has a protrusion.

The frame of the second battery module has a recess that receives the protrusion.

This configuration allows the two battery modules to be clamped together with a simple structure without using a separate clamp.

In addition, a cooling plate is disposed between the two battery modules.

The cooling plate has a hole or a notch through which the protrusion of the first battery module passes.

This configuration allows the cooling plate to face the frame of each battery module except the portion where the protrusion is present. Accordingly, the frame as well as the cell stack can be directly cooled by the cooling plate, and each of the battery modules can be effectively cooled.

According to a second aspect of the technique, in addition to the first aspect, the frame of the first battery module may have a plurality of the protrusions, and the frame of the second battery module may have a plurality of the recesses.

This configuration reduces relative displacement between the two battery modules.

According to a third aspect of the technique, in addition to the first or second aspect,
the frame of the second battery module may further have a protrusion protruding toward the first battery module, and
the frame of the first battery module may further have a recess that receives the protrusion of the second battery module.

In this case, the cooling plate may further have a hole or a notch through which the protrusion of the frame of the second battery module passes.

That is, each of the two battery modules may have both the protrusion and the recess.

According to a fourth aspect of the technique, in addition to any one of the first to third aspects,
the cooling plate may reach the outer peripheral edge of the frame of the first battery module and the outer peripheral edge of the frame of the second battery module.

That is, the outer shape of the cooling plate may be equal to or larger than the outer shape of the first battery module and the outer shape of the second battery module. With this configuration, when an impact load is applied to the battery pack from the side in the event of a vehicle collision, part or all of the impact load is transferred to the cooling plate. The impact load that is applied to the battery module can thus be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a side view of a battery pack of an embodiment;

FIG. 2 shows an exploded perspective view of the battery pack;

FIG. 3 shows a sectional view along III-III line of FIG. 1;

FIG. 4A shows the results of various performance evaluation tests for battery packs of Example 1 and Comparative Examples 1, 2;

FIG. 4B shows the results of various performance evaluation tests for battery packs of Examples 2, 3 and Comparative Example 3;

FIG. 5A shows the results of various performance tests for battery packs of Examples 5, 6 and Comparative Examples 4, 5;

FIG. 5B shows the results of various performance tests for battery packs of Examples 7, 8 and Comparative Examples 6, 7; and

FIG. 6 is a side view of a battery pack of a modification.

### DETAILED DESCRIPTION OF EMBODIMENTS

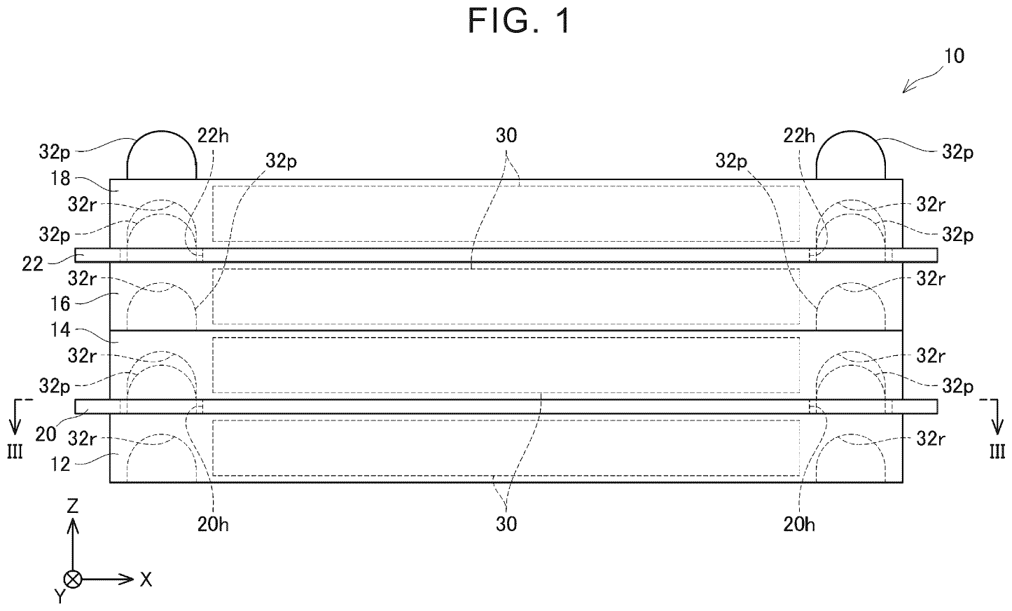

A battery pack of an embodiment will be described with reference to FIGS. 1 to 5B. A battery pack 10 is mounted on a vehicle that drives wheels by, for example, a motor. The battery pack 10 supplies electric power to the motor of the vehicle. Examples of vehicles on which the battery pack 10 is mounted include a battery electrified vehicle (BEV), a hybrid electrified vehicle (HEV), and a plug-in hybrid electrified vehicle (PHEV).

In the drawings, the up-down direction of the battery pack 10 is the Z-direction, the direction in which the long side of the top surface of the battery pack 10 extends is the X-direction, and the direction in which the short side of the top surface of the battery pack 10 extends is the Y-direction. Although not particularly limited, the battery pack 10 is disposed under the floor of the vehicle such that the Z-direction is the up-down direction of the vehicle, the X-direction is the front-rear direction of the vehicle, and the Y-direction is the left-right direction (vehicle width direction) of the vehicle. However, these directions are merely examples, and the orientation and posture of the battery pack 10 during use are not limited.

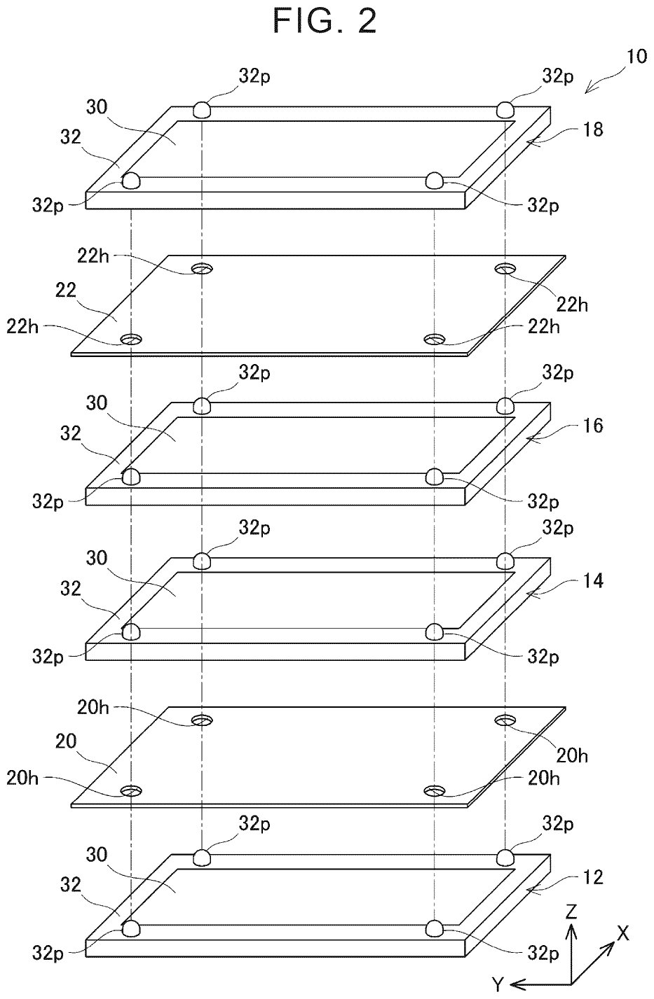

As shown in FIGS. 1 and 2, the battery pack 10 includes a plurality of battery modules 12, 14, 16, and 18 and a plurality of cooling plates 20, 22. The battery modules 12, 14, 16, and 18 include a first battery module 12, a second battery module 14, a third battery module 16, and a fourth battery module 18. Each of the battery modules has a flat rectangular parallelepiped shape that is short in the up-down direction (that is, the Z-direction in FIG. 1). The battery modules 12, 14, 16, and 18 are stacked in the up-down direction. Specifically, the second battery module 14 is disposed on the first battery module 12. The third battery module 16 is disposed on the second battery module 14. The fourth battery module 18 is disposed on the third battery module 16. The number of battery modules is not limited to four, and may be two or three, or may be five or more.

Each of the battery modules 12, 14, 16, and 18 includes a cell stack 30 and a frame 32. The battery modules 12, 14, 16, and 18 have the same configuration, but the present disclosure is not particularly limited to this. Hereinafter, a single configuration of the battery modules 12, 14, 16, and 18 will be described.

The cell stack 30 generally has a flat rectangular parallelepiped shape (or a thick plate shape). The cell stack 30 has a structure in which a plurality of battery cells is stacked in the Z-direction. Each of the battery cells is a secondary battery cell configured to be chargeable and dischargeable. The secondary battery cell is not particularly limited, but may be, for example, a lithium-ion battery cell or an all-solid-state battery cell. Each of the plurality of battery cells has a rectangular sheet shape.

The frame 32 is a rectangular frame-shaped member. The frame 32 surrounds the periphery of the cell stack 30 in a frame shape. By surrounding the cell stack 30 with the frame 32, moisture is prevented from entering into each battery cell of the cell stack 30 from the outside. The frame 32 is made of a resin material. For example, a thermoplastic resin such as a polyethylene resin is used as the resin material constituting the frame 32. The frame 32 has a plurality of protrusions 32p arranged on the upper surface (i.e., the surface facing the +Z-direction). Each of the plurality of protrusions 32p protrudes in the +Z-direction and extends toward the second battery module 14. The frame 32 has a plurality of recesses 32r arranged on the lower surface (i.e., the surface facing the −Z-direction). The plurality of recesses 32r in each of the battery modules 12, 14, 16, and 18 are disposed at the same position in XY plane as the plurality of protrusions 32p. Each of the plurality of recesses 32r has a hole capable of receiving a corresponding plurality of protrusion 32p of the battery module disposed adjacently to the lower side (i.e., −Z-direction). That is, the recess 32r of the second battery module 14 is fitted to the protrusion 32p of the first battery module 12.

The specific configurations of the protrusion 32p and the recess 32r are not particularly limited. The number of protrusions 32p and the number of recesses 32r are not limited to two or more, and may be one. Each protrusion 32p has a dome shape, and the recesses 32r have the same dome shape. However, the recesses 32r need only be formed so as to be fitted to the corresponding protrusions 32p, and the shapes of the protrusions 32p and the recesses 32r are not particularly limited. For example, the protrusion 32p and the recess 32r may have shapes that differ from each other. Alternatively, one protrusion 32p of the plurality of protrusions 32p may have the same shape as or a different shape from the other protrusions 32p of the plurality of protrusions 32p.

Each of the plurality of cooling plates 20, 22 is a plate-shaped member. Each of the cooling plates 20, 22 is made of a metal material such as aluminum. The plurality of cooling plates 20, 22 includes a first cooling plate 20 and a second cooling plate 22.

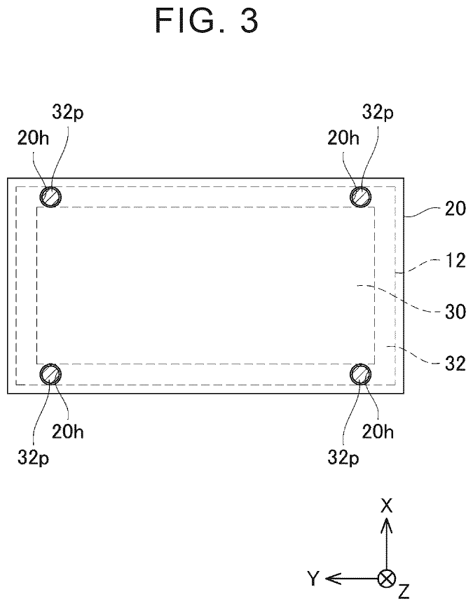

The first cooling plate 20 is disposed between the first battery module 12 and the second battery module 14. The first cooling plate 20 reaches the outer peripheral edge of the frame 32 of the first battery module 12 and the outer peripheral edge of the frame 32 of the second battery module 14. That is, as shown in FIG. 3, when viewed in plan, the outer shape of the first cooling plate 20 is equal to or larger than the outer shape of the first battery module 12. Although not shown in FIG. 3, the second battery module 14 has the same outer shape as the first battery module 12. That is, the outer shape of the first cooling plate 20 is equal to or larger than the outer shape of the second battery module 14.

The first cooling plate 20 has a through hole 20h that passes through the first cooling plate 20 in the Z-direction. The protrusion 32p of the first battery module 12 passes through the through hole 20h of the first cooling plate 20. Therefore, the protrusion 32p of the first battery module 12 passes through the through hole 20h of the first cooling plate 20 and is fitted into the recess 32r of the second battery module 14. The opening area of the through hole 20h is larger than the largest cross-sectional area of the cross section of the protrusion 32p. Here, the cross section refers to a cross section obtained when the protrusion 32p is cut in a XY plane (that is, a plane perpendicular to the Z-direction). More specifically, the opening area of the through hole 20h may be 1.1 times or more of the largest cross-sectional area of the cross-sectional area of the protrusion 32p. Further, the opening area of the through hole 20h may be 2.5 times or less the largest cross-sectional area of the cross-sectional area of the protrusion 32p. According to such a configuration, the fitting performance of the protrusion 32p to the through hole 20h of the cooling plate 20 is good. Further, it is possible to exert a sufficient effect for suppressing the positional deviation of the plurality of battery modules 12 and 14. Although not particularly limited, the through hole 20h has the same cross-section as that of the protrusion 32p. However, the through hole of the cooling plate may have a cross-section that differs from the cross-section of the protrusion 32p. The first cooling plate does not have to have the through hole. The first cooling plate may have a notch that extends therethrough in the Z-direction and that is open in the X-direction or the Y-direction. In this case, the protrusion 32p of the first battery module 12 may pass through the notch of the first cooling plate.

The second cooling plate 22 is disposed between the third battery module 16 and the fourth battery module 18. The second cooling plate 22 may be configured similarly to the first cooling plate 20. The second cooling plate 22 has a through hole 22h similar to that of the first cooling plate 20. The protrusion 32p of the third battery module 16 passes through the through hole 22h of the second cooling plate 22.

Each of the cooling plates 20, 22 has a cooling channel (not shown) formed on each of both surfaces located on opposite sides of each other in the Z-direction. A cooling medium passes through the cooling flow path. The cooling flow path is arranged in a portion of the cooling plates 20, 22 where the through holes 20h, 22h are not provided (e.g., a portion inside the through holes 20h, 22h).

In the present embodiment, no cooling plate is disposed between the second battery module 14 and the third battery module 16. The protrusion 32p of the second battery module 14 is directly fitted to the recess 32r of the second battery module 14. However, the number of the cooling plates 20, 22 is not limited to two. For example, the battery pack may include a third cooling plate disposed between the second battery module 14 and the third battery module 16. In this case, the protrusion 32p of the second battery module 14 may pass through the through hole of the third cooling plate and directly fit into the recess 32r of the second battery module 14. In addition, the battery pack may include a fourth cooling plate disposed under the first battery module 12 or over the fourth battery module 18. In this case, the cooling channels may be formed only on one side of each cooling plate.

Usually, in a battery pack in which a plurality of battery modules is stacked, the battery modules are clamped together using a separate clamp. However, when the battery modules 12, 14, 16, and 18 are arranged in the vehicle up-down direction as in the present embodiment, the battery pack 10 is disposed under the floor of the vehicle, and therefore, the underfloor height of the vehicle is increased by the amount of the separate clamp, and the vehicle cabin space is reduced. Therefore, it is desired to clamp the plurality of battery modules together with a simple structure such that the dimension of the battery pack 10 in the up-down direction (i.e., the Z-direction) does not increase.

In the present embodiment, each battery module (e.g., 12, 14) includes the cell stack 30, and the frame 32 is provided at the periphery thereof. The frame 32 of the first battery module 12 is provided with a protrusion 32p, and the frame 32 of the second battery module 14 is provided with a recess 32r into which the protrusion 32p is fitted. According to such a configuration, the two battery modules 12, 14 can be clamped together with a simple structure without using a separate restraint.

On the other hand, the battery pack 10 mounted on the vehicle is liable to generate heat by repeated fast charging. However, when the battery modules 12, 14 are cooled by the cooling plate disposed between the two battery modules 12, 14 as in the present embodiment, the cooling plate is disposed inside the frame 32 while avoiding a part where the protrusion 32p provided in the frame 32 is present. That is, the cooling plate is smaller than the frame 32. In this case, in particular, there is a possibility that the cooling capacity of the frame 32 of the battery module is insufficient.

In the present embodiment, in addition to the above configuration, the first cooling plate 20 is disposed between the two battery modules (e.g., 12, 14), and the first cooling plate 20 is provided with a plurality of through holes 20h through which the protrusion 32p of the first battery module 12 passes. According to such a configuration, the first cooling plate 20 can be made to face the frame 32 of each of the battery modules 12, 14, while avoiding only the part where the protrusion 32p is present. As a result, not only the cell stack 30 but also the frame 32 can be directly cooled by the first cooling plate 20, and the battery modules 12, 14 can be effectively cooled.

In particular, in the present embodiment, the frame 32 of the first battery module 12 is provided with a plurality of protrusions 32p, and the frame 32 of the second battery module 14 is provided with a plurality of recesses 32r. According to such a configuration, relative displacement between the two battery modules 12, 14 is suppressed.

In the present embodiment, as described above, when viewed in plan, the outer shape of the first cooling plate 20 is equal to or larger than the outer shape of the first battery module 12 and equal to or larger than the outer shape of the second battery module 14 (see FIG. 3). According to such a configuration, when a collision load is applied to the battery pack 10 from the side (i.e., the X-direction or the Y-direction) due to a vehicle collision, a part or all of the collision load is transmitted to the first cooling plate 20, whereby the collision load applied to the battery modules 12, 14 can be reduced. In the battery modules 12, 14, the frames 32, that is, the peripheral portions of the battery modules 12, 14, are clamped together by the protrusions 32p and the recesses 32r. Therefore, even if vibration in the up-down direction (i.e., the Z-direction) occurs during vehicle running, vibration of the peripheral portions of the battery modules 12, 14 is suppressed by the vibration. As a result, the vibration of each of the battery modules 12, 14 itself in the up-down direction is suppressed, and the influence on each of the battery cells (such as the separation of the positive and negative electrode distances) that may be caused by the vibration is reduced.

The third battery module 16, the fourth battery module 18, and the second cooling plate 22 can also have the same effects as those of the first battery module 12, the second battery module 14, and the first cooling plate 20.

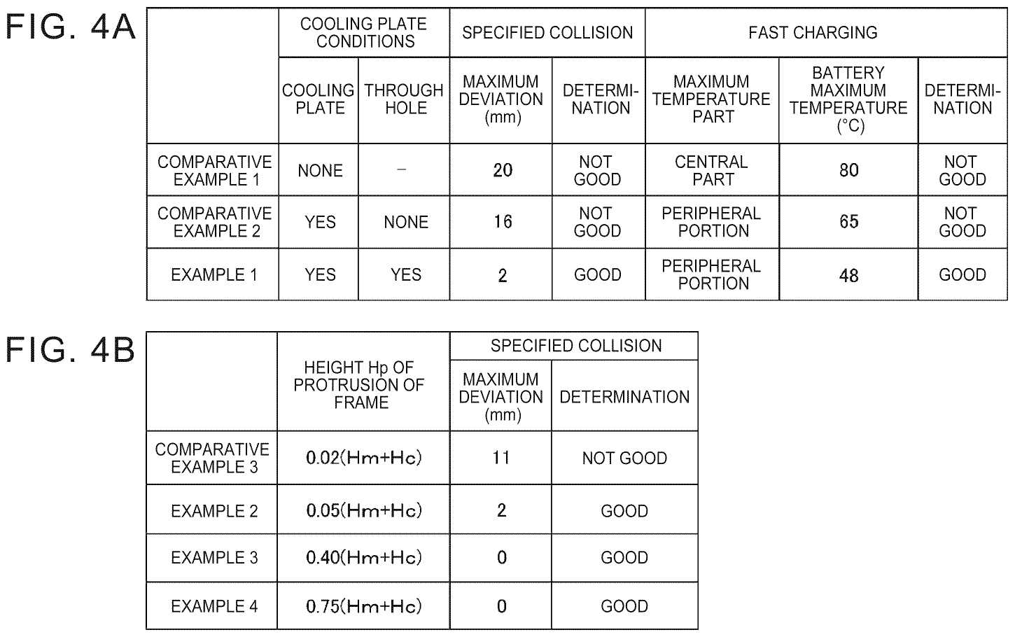

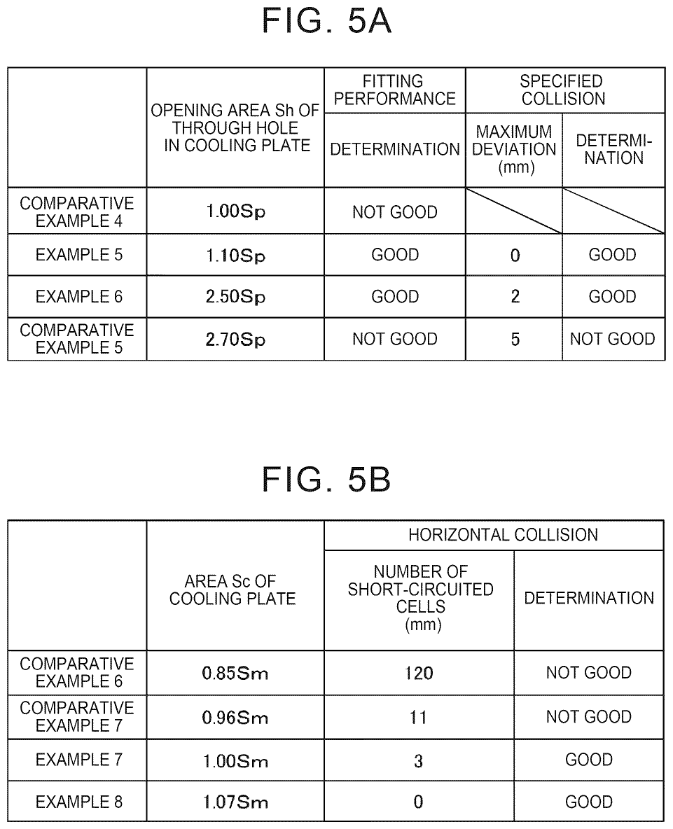

An embodiment will be described with reference to FIGS. 4A to 5B. In each example, various performance evaluation tests of the battery pack were conducted and evaluated. In Example 1, a battery pack similar to that in the embodiment was produced as described below. First, a plurality of battery cells and cooling plates 20, 22 each having the through holes 20h, 22h were prepared. Each battery cell was a monopolar cell in which a positive electrode was coated on the front and back surfaces of one positive electrode collector foil and a negative electrode was coated on the front and back surfaces of the negative electrode collector foil. A plurality of prepared battery cells was stacked in the up-down direction to prepare a cell stack 30. Next, the periphery of the cell stack 30 was solidified into a frame shape using a polyethylene resin to form the frame 32. A plurality of battery cells was integrated by the frame 32, and the battery modules 12, 14, 16, and 18 were manufactured. The frame 32 of each battery module has a plurality of protrusions 32p and a plurality of recesses 32r. The prepared battery modules 12, 14, 16, and 18 and the cooling plates 20, 22 were stacked in the up-down direction to prepare a battery pack 10.

Note that the battery cell is not limited to a monopolar cell. The battery cell may be a bipolar cell in which a positive electrode collector foil and a negative electrode collector foil are bonded to each other via a conductive adhesive, and a positive electrode and a negative electrode are coated on the front and back surfaces of the bonded collector foil.

As shown in FIG. 4A, in Example 1 and Comparative Examples 1, 2, a specified crash test and a fast charging test of the manufactured battery pack 10 were evaluated. Details of the specified crash test and the fast charging test will be described later. In Comparative Example 1, a battery pack was produced without arranging a cooling plate between two battery modules as compared with Example 1. In Comparative Example 2, a cooling plate having no through hole was prepared for Example 1, and a battery pack was prepared in the same manner as in Example 1. Since the cooling plate of Comparative Example 2 does not have a through hole, the outer shape of the cooling plate is smaller than the outer shape of each of the battery modules 12, 14, 16, and 18. Specifically, the outer shape of the cooling plate of Comparative Example 2 is located inside the protrusions 32p of the battery modules.

### Specified Crash Test

In the specified crash test, the battery modules 12, 14, 16, and 18 collide horizontally at a predetermined collision acceleration, and the maximum deviation width from the design position of the battery modules 12, 14, 16, and 18 is measured. The positions of the side surfaces of the battery modules 12, 14, 16, and 18 are flush with each other, and the deviation is 0 mm. When the deviation widths of the battery modules 12, 14, 16, and 18 are 0 mm before the collision and the maximum deviation widths of the battery modules 12, 14, 16, and 18 after the collision were less than 3 mm, their specified collision performance was determined to be “good.” When their maximum deviation widths were equal to or larger than 3 mm, their specified collision performance was determined to be “not good.” In the specified crash test, the maximum deviation widths of Comparative Examples 1, 2 were 20 mm and 16 mm, respectively, and the determination results for these comparative examples were “not good,” whereas the maximum deviation width of Example 1 was 2 mm and the determination result for this example was “good.” From the above, it was confirmed that displacement of the plurality of battery modules 12, 14, 16, and 18 is suppressed by disposing a cooling plate having an outer shape equal to or larger than the outer shape of the battery modules 12, 14, 16, and 18 between the two battery modules.

### Fast Charging Test

In the fast charging test, the temperature of each position of the battery module (e.g., 18) is measured and the maximum temperature is recorded when the battery module is charged with a predetermined fast charging current for a predetermined period of time. When the maximum temperature of the measured temperature at any position of the battery module 18 was 55° C. or less, the fast charging performance was determined to be “good.” When the maximum temperature was higher than 55° C., the fast charging performance was determined to be “not good.”

In the fast charging test of Comparative Example 1, since the cooling plate is not provided, the central portion of the battery module 18 had a maximum temperature of 80° C. and was the highest (determination result was “not good”). That is, it was confirmed that the entire battery module 18 was not sufficiently cooled. In Comparative Example 2, although the cooling plate is provided, the outer shape of the cooling plate is smaller than that of each battery module. Therefore, the peripheral portion of the battery module 18 was heated up to the maximum temperature of 65° C., and the battery module was not sufficiently cooled (determination result was “not good”). On the other hand, in Example 1, the maximum temperature was observed in the peripheral portion as in Comparative Example 2, but the maximum temperature was the lowest at 48° C. (determination result was “good”). From the above, it was confirmed that the battery modules 12, 14, 16, and 18 can be sufficiently cooled to the peripheral portion by providing the cooling plates 20, 22 whose external shapes are equal to or larger than the external shapes of the battery modules 12, 14, 16, and 18.

As shown in FIG. 4B, in Examples 2, 3 and Comparative Example 3, the specified crash test of the manufactured battery pack 10 was evaluated. In Comparative Example 3, as compared with Example 1, the height Hp of the protrusion of the battery module (that is, the dimension in the Z-direction) and the height Hm of the battery modules 12, 14, 16, and 18 and the height Hc of the cooling plates 20, 22 are defined as Hp=0.02*(Hm+Hc). As in Comparative Example 3, Hp=0.05*(Hm+Hc) in Example 2, Hp=0.40*(Hm+Hc) in Example 3, and Hp=0.75*(Hm+Hc) in Example 4.

In Comparative Example 3, the maximum deviation range was 11 mm (determination result was “not good”). The maximum deviation width of Example 2 was as small as 2 mm, and the maximum deviation widths of Examples 3, 4 were zero (determination result was “good” for all of these examples). From the above, it was confirmed that when the height Hp of the protrusion 32p of the battery modules 12, 14, 16, and 18 is not less than 5% and not more than 75% of the sum of the height Hm of the battery modules 12, 14, 16, and 18 and the height Hc of the cooling plates 20, 22, the positional deviation of the plurality of battery modules 12, 14, 16, and 18 is suppressed. In addition, it was confirmed that when the height Hp of the protrusions 32p of the battery modules 12, 14, 16, and 18 is 40% or more, it is more effective in suppressing misalignment of the plurality of battery modules 12, 14, 16, and 18.

As shown in FIG. 5A, in Examples 5, 6 and Comparative Examples 4, 5, the fitting test and the specified crash test were evaluated. The fitting test will be described later. In Comparative Example 4, as compared with Example 4, the relationship between the opening area Sh of each through hole 20h, 22h of the cooling plates 20, 22 and the cross-sectional area Sp of each protrusion 32p of the battery modules 12, 14, 16, and 18 is defined as Sh=1.00*Sp. The cross-sections of the through holes 20h, 22h of the cooling plates 20, 22 and the protrusions 32p of the battery modules 12, 14, 16, and 18 have the circular shape. As in Comparative Example 4, Example 5 defines Sh=1.10*Sp, Example 6 defines Sh=2.50*Sp, and Comparative Example 5 defines Sh=2.70*Sp.

### Fitting Test

In the fitting test, the fitting performance between the through hole 20h of the cooling plate (e.g., 20) and the protrusion 32p of the battery module (e.g., 12) at the time of assembling the battery pack 10 was evaluated. The cooling plate 20 is lowered with respect to the battery module 12 and the cooling plate 20 and the battery module 12 are fitted together by the force of the self-weight of the cooling plate 20. When the cooling plate 20 fitted on the protrusion 32p of the battery module 12 is pulled by a force that is 1.5 times the self-weight but the cooling plate 20 does not come off from the battery module 12, the fitting performance was determined to be “good.” On the other hand, when the cooling plate 20 was lowered toward the battery module 12 but the cooling plate 20 and the battery module 12 are not fitted together by the force of the self-weight of the cooling plate 20, or when the cooling plate 20 fitted on the protrusion 32p of the battery module 12 was pulled up with a force that was 1.5 times the self-weight and the cooling plate 20 came off from the battery module 12, the fitting performance was determined to be “not good.”

In the fitting test, the fitting performance of Comparative Example 4 was “not good.” Here, the opening area of the through hole 20h of the cooling plate 20 is equal to the cross-sectional area Sp of the protrusion 32p of the battery module 12. In other words, there is no gap between the through hole 20h of the cooling plate 20 and the protrusion 32p of the battery module 12. Therefore, the protrusion 32p cannot easily pass through the through hole 20h of the cooling plate 20. On the other hand, the fitting performance of Examples 5, 6 was “good.” However, the fitting performance of Comparative Example 7 was “not good.” From the above, when the opening area Sh of each through hole 20h, 22h of the cooling plates 20, 22 is 1.1 times or more and 2.5 times or less of the cross-sectional area of each protrusion 32p of the battery modules 12, 14, 16, and 18, it was confirmed that the fitting performance was good.

In the specified crash test, the maximum deviation widths of Examples 5, 6 were 0 mm and 2 mm, respectively, and the determination results for these examples were “not good,” whereas the maximum deviation width of Comparative Example 5 was 5 mm and the determination result for this example was “good.” From the above, it was confirmed that when the opening area Sh of each through hole 20h, 22h of the cooling plates 20 and 22 is 1.1 times or more and 2.5 times or less of the cross-sectional area of each protrusion 32p of the battery modules 12, 14, 16, and 18, it is more effective in suppressing the positional deviation of the plurality of battery modules 12, 14, 16, and 18. In Comparative Example 4, the specified crash test was not performed.

As shown in FIG. 5B, a horizontal crash test was evaluated in Examples 7, 8 and Comparative Examples 6, 7. The horizontal crash test will be described later. In Comparative Example 6, as compared with Example 1, the relationship between the area Sc of the cooling plates 20, 22 and the area Sm of the battery modules 12, 14, 16, and 18 is defined as Sc=0.85*Sm. As in Comparative Example 6, Sc=0.96*Sm in Comparative Example 7, Sc=1.00*Sm in Example 7, and Sc=1.07*Sm in Example 8.

### Horizontal Crash Test

In the horizontal crash test, the battery pack 10 is crushed in the horizontal direction (i.e., XY-plane direction) by external pressure. Measure each cell voltage, and measure the number of cells that will be shorted when a crusher is pushed in under the specified crush condition. When the number of short-circuited cells was less than five, the horizontal collision performance was determined to be “good.” When the number of short-circuited cells is five or more, the horizontal collision performance was determined to be “not good.” In Comparative Examples 6, 7, the area Sc of the cooling plates 20, 22 was smaller than the area Sm of the battery modules 12, 14, 16, and 18, and the number of short-circuited cells was 120 and 11, respectively (determination result was “not good”). On the other hand, in Examples 7, 8, the area Sc of the cooling plates 20, 22 was equal to or larger than the area Sm of the battery modules 12, 14, 16, and 18, and the number of short-circuited cells was as small as three and zero, respectively (determination results for these examples were “good”). This is assumed to mean that, when the area Sc of the cooling plates 20, 22 is equal to or larger than the area Sm of the battery modules 12, 14, 16, and 18, that is, the outer shape of the cooling plates 20, 22 is equal to or larger than the outer shape of the battery modules 12, 14, 16, and 18, some or all of the crushing load is transmitted to the cooling plates 20, 22 before the battery modules 12, 14, 16, and 18, and the crushing load applied to the battery modules 12, 14, 16, and 18 is reduced.

### Modifications

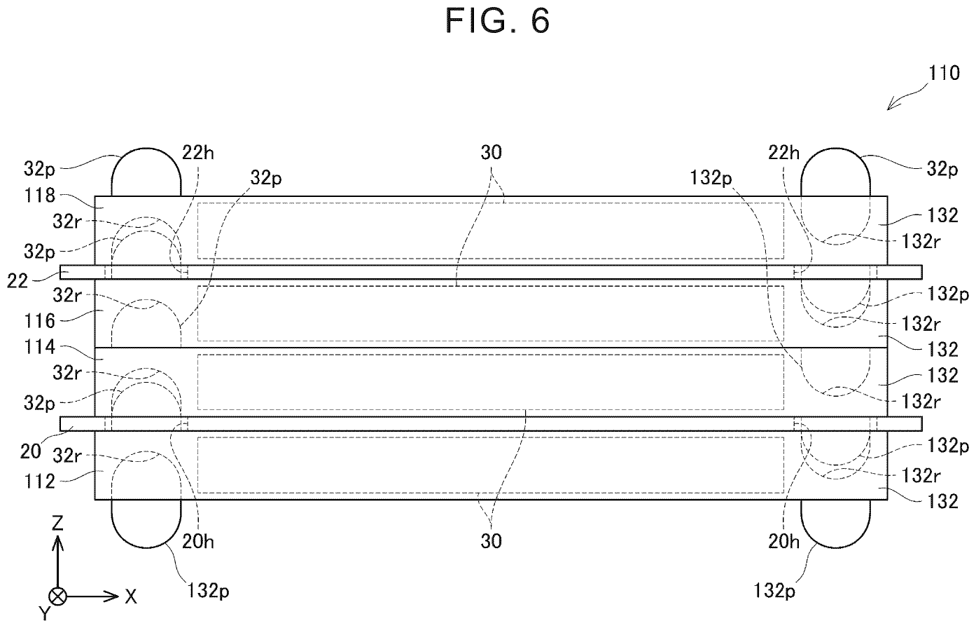

A configuration different from that of the first embodiment of the modification will be described with reference to FIG. 6. The battery pack 110 of the modified example may include a plurality of modules 112, 114, 116, and 118. The modules 112, 114, 116, and 118 may be different from each other in configuration of the frame 132. In the frame 132, part of the recesses 32r of the embodiment disposed on the lower surface (that is, the surface facing the −Z-direction) may be changed to the plurality of protrusions 132p. The recesses 32r and the protrusions 132p may be alternately arranged along the periphery of the frame 32. The protrusion 132p may extend toward the battery module disposed adjacently to the lower side. In the frame 132, part of the protrusions 32p of the embodiment arranged on the upper surface (that is, the surface facing the +Z-direction) may be changed to the plurality of recesses 132r. The protrusions 32p and the recesses 132r may be alternately arranged along the periphery of the frame 32. Each of the recesses 132r may have a hole that can receive a corresponding protrusion 132p of the battery module disposed adjacent to the upper side (i.e., the +Z-direction). That is, the recess 132r of the first battery module 112 may be fitted on the protrusion 132p of the second battery module 114 through the cooling plate 20. Even with this configuration, the two battery modules (112, 114/116, 118) can be clamped together with a simple structure. In addition, not only the cell stack 30 but also the frame 132 can be directly cooled by the cooling plates 20 and 22, and the battery modules 112, 114, 116, and 118 can be effectively cooled.

What is claimed is:

1. A battery pack comprising:
a first battery module and a second battery module that are stacked together; and
a cooling plate disposed between the first battery module and the second battery module, wherein:
each of the first battery module and the second battery module includes
a cell stack that is a plurality of battery cells stacked together, and
a frame made of resin, the frame having a frame shape and surrounding a periphery of the cell stack;
the frame of the first battery module has a protrusion protruding toward the second battery module;
the frame of the second battery module has a recess that receives the protrusion of the first battery module; and
the cooling plate has a hole or a notch through which the protrusion passes.

2. The battery pack according to claim 1, wherein:
the frame of the first battery module has a plurality of the protrusions; and
the frame of the second battery module has a plurality of the recesses.

3. The battery pack according to claim 1, wherein:
the frame of the second battery module further has a protrusion protruding toward the first battery module;
the frame of the first battery module further has a recess that receives the protrusion of the second battery module; and
the cooling plate further has a hole or a notch through which the protrusion of the frame of the second battery module passes.

4. The battery pack according to claim 1, wherein the cooling plate reaches an outer peripheral edge of the frame of the first battery module and an outer peripheral edge of the frame of the second battery module.
